(19) United States
(12) Patent Application Publication
(10) Pub. No.: US 2024/0238805 A1
(43) Pub. Date: Jul. 18, 2024

(54) METHOD AND SYSTEM FOR ORE PROCESSING WITH APPLICATION OF ULTRASOUND TO THE FLOTATION FROTH

(71) Applicants: Vale S.A., Rio de Janeiro (BR); Universidade de São Paulo - USP, São Paulo (BR)

(72) Inventors: Lívia Marques FAUSTINO, São Paulo (BR); Flávia Paulucci Cianga SILVAS, Osasco (BR); Thiago Cesar de Souza PINTO, Belo Horizonte (BR); Flávio BUIOCHI, JundiaÍ (BR); Guilherme Victor SELICANI, São Paulo (BR); André Soares BRAGA, São José dos Campos (BR); Virginia Paula NYKÄNEN, Espoo (FI); Laurindo Salles LEAL FILHO, São Paulo (BR); Alfredo Moises SARKIS, Volta Redonda (BR)

(21) Appl. No.: 18/562,153

(22) PCT Filed: May 13, 2022
(86) PCT No.: PCT/BR2022/050167

§ 371 Date: Nov. 17, 2023

(30) Foreign Application Priority Data
May 17, 2021 (BR) 1020210095717

(51) Int. Cl. B03D 1/02; B03D 1/18; B06B 1/00

(52) U.S. Cl. CPC B03D 1/02; B03D 1/18; B06B 1/00

(57) ABSTRACT

This invention relates to an ore beneficiation process by flotation. In this context, an ore beneficiation system is provided with application of ultrasound to the flotation froth comprising an air-emission ultrasonic transducer positioned above the flotation froth, with the ultrasonic transducer being adapted to emit ultrasonic waves towards the flotation froth. This invention also provides an ore beneficiation process associated with the system described above. Thus, this invention provides a process and system for ore beneficiation with the application of ultrasound to the flotation froth without immersing the ultrasonic transducer into the ore slurry. The current invention can partially remove the liquid film that resides between the air bubbles, thereby enhancing metallurgical recovery rates. Furthermore, it can be employed to effectively counteract the persistence of three-phase froth resulting from flotation, thereby improving the efficiency of processes associated with water and waste management.

### FIELD OF THE INVENTION

This invention is related to ore beneficiation processes. In particular, this invention relates to ore beneficiation processes carried out by flotation. This invention also relates to an ore beneficiation system.

### FUNDAMENTALS OF THE INVENTION

Ore beneficiation is understood as the set of fundamental operations in the preparation of the mineral asset to make it suitable for future use in other industries (metallurgical, chemical, etc.). It aims to segregate the valuable material contained within the mineral from that with no commercial value or to size it appropriately to meet market demands. The first stages of ore processing are dedicated to the comminution and homogenization of the material collected in the mines. Next, the material is selected by sieving and classification techniques to apply concentration methods appropriate to the particle size of the material. Briefly, gravity methods (concentrating chutes, Reichert concentrator, static and oscillatory tables, jigs, spirals, and centrifugal concentrators) are used to separate larger particles.

Flotation is employed as a method to separate ore particles with an average diameter smaller than 0.15 mm. This process results in the formation of a dense slurry, which, after settling, undergoes a filtration procedure to yield the concentrate for subsequent utilization within the industrial production chain.

Flotation is a mineral separation process that exploits the variation in the affinity of air bubbles to selectively adhere to the surfaces of solids found within an aqueous mixture or slurry. Particles adhered to the air bubbles are brought to the surface, while the rest continue to be retained in the liquid phase. Various chemical reagents can be used to change the surface of the interest minerals' properties in order to separate them from the mixture, such as: (i) collectors, which adhere to the surface of the particles, making them hydrophobic; (ii) frothers, which contribute to bubble size stability; and (iii) modifiers, which are activators, depressants, and pH modulators that alter the selectivity of the process.

Iron ore flotation, for example, falls into the category of reverse flotation, as the desired material remains immersed while the impurities, which are mostly quartz (silica or SiO₂), are floated and sent to waste. The effectiveness of a separation method can be assessed through the metallurgical recovery rate, which measures the quantity of the valuable element obtained during the ore concentration process, and its purity, determined by the concentration of the valuable element within the ore. Industrial practice demonstrates that there is a trade-off between the recovery rate and the purity of the material obtained by the beneficiation method. In other words, methods of obtaining ore with a high purity content usually imply lower recovery rates, that is, ore waste occurs in the separation procedure. The opposite is also true, as methods with high recovery rates usually provide materials with lower purity content. This alone justifies the search for new technologies to improve beneficiation performance, such as ultrasound techniques.

A series of scientific publications point to an increase in efficiency in beneficiation processes using different ultrasound techniques. The use of ultrasonic transducers in experimental apparatus designed to generate acoustic cavitation is common. In these cases, power transducers, usually operating at a frequency of 20 to 100 kHz, generate pressure waves in a fluid alternating in compression and rarefaction cycles. During the rarefaction phase, the negative pressure generated in the acoustic field is sufficient to overcome the fluid's molecular binding forces, resulting in the formation of microbubbles. The subsequent compression phase of the wave cycle causes these bubbles to collapse abruptly, generating localized high-energy pulses. In this type of equipment, the energy expelled when the bubbles collapse is used to clean the surface of solids submerged in the fluid.

State of the art documents reveal increased recovery rates in the flotation process, obtained through the use of ultrasound in the pre-conditioning stage of the ore slurry. The cavitation generated by the acoustic field applied to the slurry facilitates the cleaning of the ore particles' surfaces, thereby enhancing the effectiveness of the collecting chemical reagents employed in the flotation process. This approach is carried out in several experiments, for example, in the beneficiation of magnesite, galena, blende, chalcopyrite, pyrite, oil shale, and coal.

Several techniques for applying ultrasound in the ore flotation process are currently known. Below are some of the documents that reveal such methodologies.

Document U.S. Pat. No. 10,464,075B2 describes a concentration method through flotation that employs anisotropic collecting particles in conjunction with an ultrasonic transducer. The ultrasonic transducer is positioned inside a mixing chamber for the collecting particles with the slurry.

Document CN101637756B describes a system that uses ultrasonic waves to treat ore slurry, comprising: (i) an ultrasonic transducer; (ii) a closed casing fixed around the ultrasonic transducer, which is made of steel; (iii) a lead transfer tube positioned on the upper surface of the fixed casing; (iv) an ultrasonic transducer positioning rod fixedly connected to the side end of the fixed casing of the ultrasonic transducer; and (v) a fixing clip that is connected to the positioning rod of the ultrasonic transducer. The CN101637756B system can be used separately in an ore slurry treatment tank, or a plurality of ultrasound generators can be combined for use and arranged in various ways, so that the height and direction of rotation can be conveniently adjusted.

Document DE4420210A1 describes a process for the separation of solids and hydrophobic substances in suspension with the support of flotation, in which the bonds in the suspension between solids and hydrophobic substances are dissolved with the support of ultrasound. In the DE4420210A1 process, ultrasound waves can be applied to different stages and portions of the reservoir.

The scientific article entitled “Effect of ultrasonic pretreatment time on coal flotation” (Kopparthi et al.) describes a study that aims to evaluate the use of ultrasound waves in the treatment of mineral coal in the flotation concentration process. For each of the experiments carried out in this document, 500 g of coal sample was mixed with water for three minutes. After mixing, the coal slurry was conditioned with flotation reagents; a collector and frothing agent. For ultrasonic pretreatment, the ultrasonic probe was inserted into the cell and the coal slurry was subjected to pretreatment before conditioning with reagents.

As evident from the documents referred to above, all of them outline techniques for implementing ultrasound in ore beneficiation, particularly within the context of the flotation process. However, all the processes described above employ ultrasound by immersing the transducer within the ore slurry. In this embodiment, the ultrasound waves do not only act on the froth, but on the flotation slurry, and can change froth parameters (bubble size distribution) without being desirable. This type of application also leads to heightened turbulence within the separation zone, potentially causing the dislodging of particles meant for flotation from the bubbles, particularly larger particles.

Furthermore, the scientific article titled “Effect of ultrasound on separation selectivity and efficiency of flotation” (Cilek et al.) demonstrated that situating the transducer near the froth zone diminished the process efficiency, as immersing the transducer emitting ultrasonic waves led to bubble coalescence, essentially causing them to merge, leading to rupture and subsequent loss of larger mineral particles adhered to the bubbles. In other words, in this case, the use of ultrasound immersed close to the froth impairs mineral recovery.

The current invention seeks to address the previously mentioned issues as there is currently no specific method in the state of the art that mitigates such undesired side effects when employing ultrasound in the ore beneficiation process by flotation.

### SUMMARY OF THE INVENTION

As a primary objective, this invention aims to provide a process and system for ore beneficiation with the application of ultrasound to the flotation froth without immersing the ultrasonic transducer.

As a secondary objective, this invention aims to provide an ore beneficiation process and system utilizing ultrasound applied to the flotation froth, able to drain the liquid film that resides between the air bubbles, thereby fostering a higher recovery rate of the target mineral.

As a tertiary objective, this invention aims to offer an ore beneficiation process and system incorporating ultrasound applied to waste, able to mitigate the persistence of three-phase froths, as the excessive stability of such froth, stemming from the presence of residual flotation reagents and mineral particles, diminishes the efficiency of the processes associated with water and waste management.

In order to achieve the referred objectives, this invention provides an ore beneficiation process with the application of ultrasound to the flotation or waste froth comprising the steps of (i) positioning an air-emission ultrasonic transducer above the froth and (ii) emitting ultrasonic waves from the air-emission ultrasonic transducer towards the froth.

Additionally, this invention provides an ore beneficiation system with application of ultrasound to the flotation or waste froth, comprising an air-emitting ultrasonic transducer positioned above the froth, with the ultrasonic transducer being adapted to emit ultrasonic waves towards the froth.

### BRIEF DESCRIPTION OF THE FIGURES

The detailed description below refers to the attached figures and their respective reference numbers.

FIG. 1 illustrates a schematic arrangement according to the first embodiment of this invention.

FIG. 2 illustrates a schematic arrangement according to the second embodiment of this invention.

FIG. 3 shows a schematic sectional view of an air-emission ultrasonic transducer used by this invention.

FIG. 4 illustrates the results of the relationship between the power variable “gain”, supplied to the ultrasonic transducer, and the three-phase froth suppression rate in a flotation experiment with iron ore, according to the first embodiment of this invention.

FIG. 5 shows the results of the relationship between the variable power “gain” supplied to the ultrasonic transducer and the recovery rate of Fe and SiO₂ in the waste, according to the second embodiment of this invention.

### DETAILED DESCRIPTION OF THE INVENTION

Preliminarily, it is emphasized that the description that follows will start from a preferred embodiments of the invention. However, as will be apparent to those skilled in the art, the invention is not limited to that particular embodiments.

This invention solves the technical problem described above by providing an ore beneficiation process and system with the application of ultrasound to the flotation or waste froth, where the ultrasonic transducer is not immersed in the ore slurry.

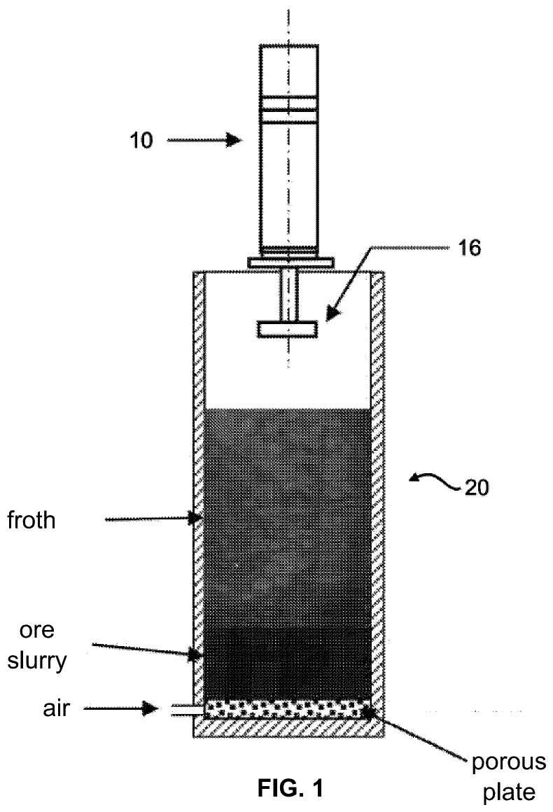

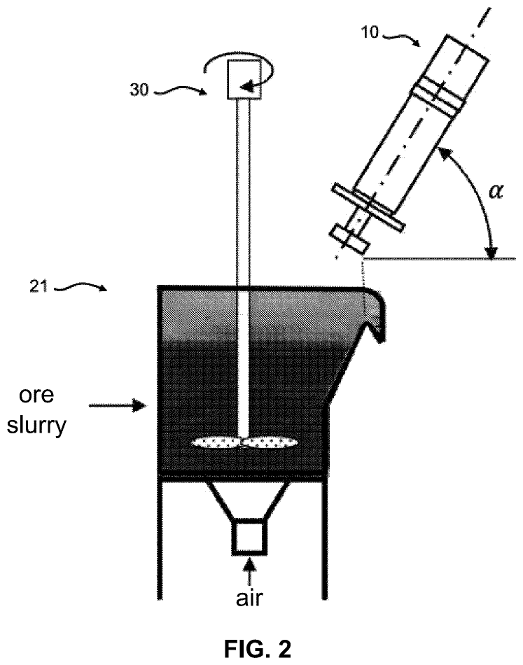

As illustrated in FIGS. 1 and 2, an air-emission ultrasonic transducer (10) is provided above the froth, which is located on the ore slurry contained within a reservoir (20) or flotation tank (21).

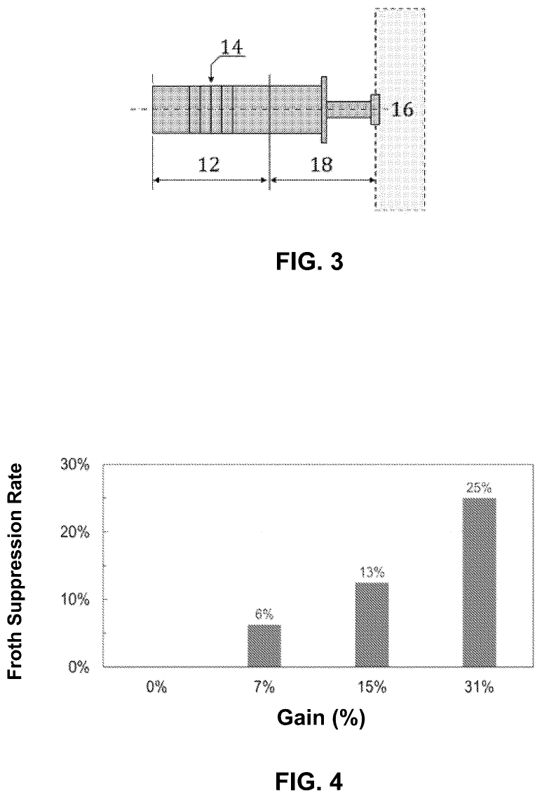

The air-emission ultrasonic transducer (10) is preferably a high-power transducer that employs a Langevin transducer (12) positioned in the rear portion of the ultrasonic transducer (10), as illustrated in FIG. 3. Langevin transducers use mechanical power from a set of piezoelectric ceramics (14) stacked and pressed by metallic masses through a high-resistance screw. Its activation occurs through the harmonious application of electrical voltage to the electrodes connected to the surfaces of the piezoelectric ceramics, which in turn vibrate in a longitudinal mode within the device.

Preferably, an air-emission plate (16) is coupled to a mechanical amplifier (18), both positioned in the anterior portion of the ultrasonic transducer (10). Optionally, the air-emission plate (16), which may be circular or rectangular, comprises grooves or steps machined into its surface. The depth of the step is preferably the size of half the length of the wave propagating in air, which induces a phase delay in the wave emitted on the recessed surfaces concerning the others. Thus, the destructive wave interferences inherent to the axisymmetric bending vibrational modes of smooth cylindrical radiating plates are avoided.

The reservoir (20) and the flotation tank (21), on which the ultrasonic transducer is positioned, preferably comprise an air inlet located in the lower portion thereof, as shown in FIGS. 1 and 2. The lower portion of the reservoir (20) and the flotation tank (21) may comprise, for example, a porous plate for uniform air distribution at the base of the equipment.

In the first embodiment, illustrated in FIG. 1, the ultrasonic transducer (10) is positioned over the reservoir (20) at a 90° angle, aiming to suppress persistent mineralized three-phase froths, since the excessive stability of the froth, caused by the presence of residual flotation reagents and mineral particles, diminishes the efficiency of the water and waste management processes. The mechanical vibration promoted by the ultrasonic waves generated by the ultrasonic transducer (10) on the flotation three-phase froth effluent breaks the structure of the bubbles and suppresses the froth which hinders the pumping and thickening processes of this flow.

The first embodiment of this invention, as illustrated in FIG. 1, can be used in the flotation effluent froth flow chutes, pump boxes, and/or in the thickener feeding area.

FIG. 4 shows the results of the relationship between the power variable “gain” supplied to the ultrasonic transducer (10) and the froth suppression rate in the reservoir (20) for the suppression of three-phase froths in an experiment with iron ore, according to the first embodiment of this invention.

In a second embodiment, as illustrated in FIG. 2, the ultrasonic transducer (10) is positioned on the flotation tank (21) at an a angle less than 90°, aiming to drain, partially, the liquid film between the air bubbles. In this embodiment, introducing air into the lower section of the reservoir, along with the presence of a stirring medium (30), encourages the creation of bubbles, which transport hydrophobic particles and can, over time, generate hydrodynamic currents capable of transporting hydrophilic particles. Fundamentally, the mechanical vibration induced by the ultrasonic waves produced by the ultrasonic transducer (10) within the flotation froth layer enhances the drainage of the water lamellae (the liquid film between the air bubbles), which entrap hydrophilic particles within the froth, facilitating their return from the forth to the submerged phase. For the iron ore reverse flotation process, hematite is the hydrophilic particle of interest.

Preferably, the stirring medium (30) is composed of a rotating rod and an impeller. Industrially, the stirring system, whether self-aerated or by forced aeration, can be configured by a rotor/stator with an impeller.

In the second embodiment of this invention, the aim is not to collapse the bubbles but rather to facilitate the drainage of the liquid film between them; therefore, the application of ultrasound is conducted in a more controlled manner, in contrast to the first embodiment.

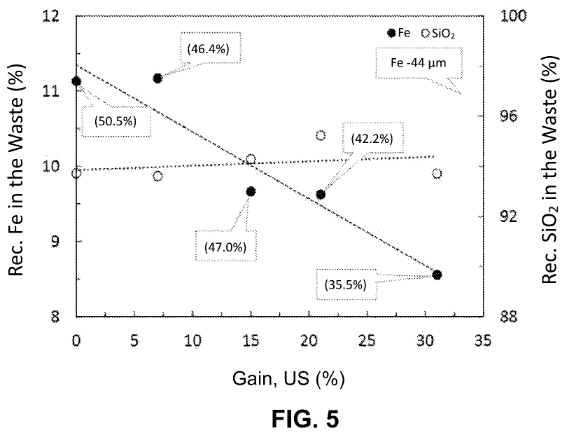

FIG. 5 shows the results of the relationship between the variable power “gain” supplied to the ultrasonic transducer (10) and the recovery rates of Fe and SiO₂ in waste according to the second embodiment of this invention. In this embodiment, an increased global metallurgical recovery by 2.5% is observed compared to the flotation process without ultrasound. The increased iron recovery is even more significant for the fine fraction (<44 μm), reaching up to 15%.

Therefore, as explained above, this invention provides an ore beneficiation process with the application of an ultrasound system to the flotation or waste froth, able to drain, partially, the liquid film that resides between the air bubbles, thereby fostering a higher recovery rate of the target mineral. Additionally, the system and process described above can be used to suppress persistent three-phase froths, improving the efficiency of the processes involved in water and waste management. Therefore, by introducing a process and system that eliminate the need for immersing the ultrasonic transducer in the ore slurry, this invention effectively mitigates the issues encountered in the current state of the art, simultaneously achieving improved metallurgical recovery results in flotation and effectively suppressing persistent three-phase froth.

Numerous variations affecting the scope of protection of this application are allowed. Thus, it must reinforces pointed out that this invention is not limited to the particular configurations/embodiments described above.

1.-10. (canceled)

11. A process of ore beneficiation with application of ultrasound to a flotation or waste froth, comprising:
positioning an air-emission ultrasonic transducer above the flotation or waste froth by adjusting an inclination angle of the air-emission ultrasonic transducer in relation to a surface of the flotation or waste froth so that the inclination angle is less than 90°; and
emitting ultrasonic waves from the air-emission ultrasonic transducer towards the flotation or waste froth.

12. The process of claim 11, further comprising stirring a mixture formed by an ore slurry and the flotation or waste froth using at least one stirring medium.

13. The process of claim 11, wherein positioning the air-emission ultrasonic transducer is carried out over at least one of a flotation effluent froth flow chute, or a feeding area of a thickening tank.

14. An ore beneficiation system with application of ultrasound to a flotation or waste froth, comprising:
an air-emission ultrasonic transducer positioned above the flotation or waste froth, the air-emission ultrasonic transducer being adapted to emit ultrasonic waves toward the flotation or waste froth; and
wherein an angle of inclination of the air-emission ultrasonic transducer relative to a surface of the flotation or waste froth is less than 90°.

15. The system of claim 14, wherein a distance and the angle of inclination of the air-emission ultrasonic transducer with respect to the surface of the flotation or waste froth is variable and adjustable.

16. The system of claim 14, further comprising at least one stirring medium adapted to agitate a mixture formed by an ore slurry and the flotation or waste froth.

17. The system of claim 14, wherein the flotation or waste froth is located in at least one of a flotation effluent froth flow chute, or a feeding area of a thickening tank.
